(19) United States
(12) Patent Application Publication
(10) Pub. No.: US 2013/0021212 A1
(43) Pub. Date: Jan. 24, 2013

(54) EXTERNAL CASING STRUCTURE FOR PROVIDING AN ANTENNA FUNCTION

(71) Applicants: CHE-YI LAI, NEW TAIPEI CITY (TW); JIA-WEI CHANG, NEW TAIPEI CITY (TW); CHI-KANG HSIA, NEW TAIPEI CITY (TW); WEN-CHIN YAO, NEW TAIPEI CITY (TW)

(72) Inventors: CHE-YI LAI, NEW TAIPEI CITY (TW); JIA-WEI CHANG, NEW TAIPEI CITY (TW); CHI-KANG HSIA, NEW TAIPEI CITY (TW); WEN-CHIN YAO, NEW TAIPEI CITY (TW)

(73) Assignee: SILITECH TECHNOLOGY CORPORATION, NEW TAIPEI CITY (TW)

(21) Appl. No.: 13/236,879

(22) Filed: Sep. 20, 2011

(30) Foreign Application Priority Data
Jul. 18, 2011 (TW) 100213152

(51) Int. Cl. H01Q 1/24

(52) U.S. Cl. 343/702

(57) ABSTRACT

An external casing structure for providing an antenna function includes a metal casing unit, an antenna unit, and an appearance decoration unit. The metal casing unit includes at least one metal casing. The antenna unit includes at least one antenna layer disposed on the metal casing, and the antenna layer is extended from the inner surface of the metal casing to the outer surface of the metal casing. The appearance decoration unit includes at least one appearance decoration layer disposed on the outer surface of the metal casing, and one part of the antenna layer is covered with the appearance decoration layer.

### BACKGROUND OF THE INVENTION

1. Field of the Invention

The instant disclosure relates to an external casing structure, and more particularly, to an external casing structure for providing an antenna function.

2. Description of Related Art

A conventional mobile phone includes an elongated outer casing that encloses inner components therein and that is not easy to carry along within the palm of the user, and an antenna projecting outwardly from the outer casing. Since most of the users are in the habit of carrying the mobile phone in user's pockets such that the antenna tangles up with the user's pocket whenever he fetches the mobile phone from the pocket. In order to solve the aforesaid problem and to enhance the outward appearances thereof, the antenna can be a patch type and is confined within the outer casing of the mobile phone so as not to be visible, and includes a printed circuit board. Under this condition, no antenna is visible in the mobile phone of the newest production.

A conventional mobile phone include a first half and a second half The first and second halves of the conventional mobile phone are generally made from metal material or are electroplated. Since metal can interfere with sending and receiving signals of the antenna mounted within the first and second halves, an opening is formed through one of the first and second halves. A non-conductive material can be provided in the opening so as to retain the antenna free from being disturbed by the electromagnetic fields.

### SUMMARY OF THE INVENTION

One aspect of the instant disclosure relates to an external casing structure for providing an antenna function.

One of the embodiments of the instant disclosure provides an external casing structure for providing an antenna function, comprising: a metal casing unit, an antenna unit, and an appearance decoration unit. The metal casing unit includes at least one metal casing. The antenna unit includes at least one antenna layer disposed on the at least one metal casing, wherein the at least one antenna layer is extended from the inner surface of the at least one metal casing to the outer surface of the at least one metal casing. The appearance decoration unit includes at least one appearance decoration layer disposed on the outer surface of the at least one metal casing, wherein one part of the at least one antenna layer is covered with the at least one appearance decoration layer.

Another one of the embodiments of the instant disclosure provides an external casing structure for providing an antenna function, comprising: a plastic casing unit, an antenna unit, and an appearance decoration unit. The plastic casing unit includes at least one plastic casing. The antenna unit includes at least one antenna layer disposed on the at least one plastic casing, wherein the at least one antenna layer is extended from the inner surface of the at least one plastic casing to the outer surface of the at least one plastic casing. The appearance decoration unit includes at least one appearance decoration layer disposed on the outer surface of the at least one plastic casing, wherein one part of the at least one antenna layer is covered with the at least one appearance decoration layer.

Therefore, the appearance decoration layer can be disposed on the outer surface of the metal casing or the plastic casing to prevent the antenna layer from being touched directly by the user, thus the antenna layer can be used to transmit or receive signals normally.

To further understand the techniques, means and effects of the instant disclosure applied for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1 shows a lateral, cross-sectional, schematic view of the external casing structure according to the first embodiment of the instant disclosure;

FIG. 2 shows a lateral, cross-sectional, schematic view of the external casing structure according to the second embodiment of the instant disclosure;

FIG. 3 shows a lateral, cross-sectional, schematic view of the external casing structure according to the third embodiment of the instant disclosure; and

FIG. 4 shows a lateral, cross-sectional, schematic view of the external casing structure according to the fourth embodiment of the instant disclosure.

### DETAILED DESCRIPTION OF THE PREFERRED EMBODIMENTS

### First Embodiment

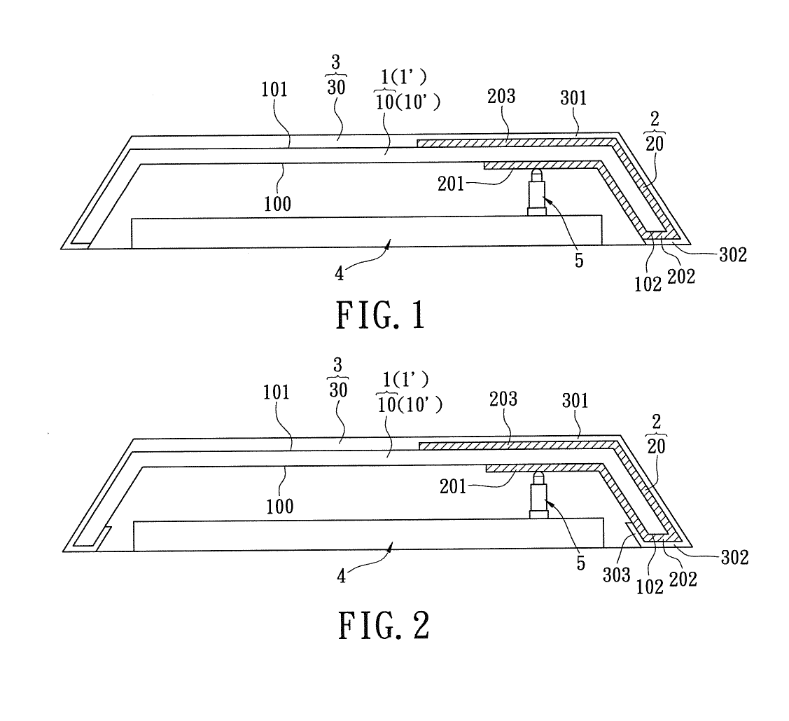

Referring to FIG. 1, where the first embodiment of the instance disclosure provides an external casing structure for providing an antenna function, comprising: a metal casing unit 1, an antenna unit 2, and an appearance decoration unit 3, and the external casing structure can be applied to any electronic device such as a mobile phone, a tablet computer, etc.

The metal casing unit 1 includes at least one metal casing 10, and the metal casing 10 has an inner surface 100, an outer surface 101 corresponding to the inner surface 100, and at least one bending surface 102 formed between the inner surface 100 and the outer surface 101. In addition, the antenna unit 2 includes at least one antenna layer 20 disposed on the metal casing 10, and the antenna layer 20 can be extended from the inner surface 100 of the metal casing 10 to the outer surface 101 of the metal casing 10. The appearance decoration unit 3 includes at least one appearance decoration layer 30 disposed on the outer surface 101 of the metal casing 10, and one part of the antenna layer 20 can be covered with the appearance decoration layer 30.

For example, the metal casing unit 1 can be replaced by a plastic casing unit 1′ including at least one plastic casing 10′. Moreover, the antenna layer 20 has a first antenna track 201 disposed on the inner surface 100 of the metal casing 10, a second antenna track 202 disposed on the bending surface 102 of the metal casing 10 and extended from the first antenna track 201, and a third antenna track 203 disposed on the outer surface 101 of the metal casing 10 and extended from the second antenna track 202. In addition, the appearance decoration layer 30 has a first appearance decoration portion 301 disposed on the outer surface 101 of the metal casing 10 to cover the third antenna track 203 and a second appearance decoration portion 302 disposed on the bending surface 102 of the metal casing 10 to cover the second antenna track 202, and the second appearance decoration portion 302 can be extended from the first appearance decoration portion 301. Therefore, the appearance decoration layer 30 can be used to prevent the antenna layer 20 from being touched directly by the user, thus the antenna layer 20 can be used to transmit or receive signals normally. Furthermore, the antenna layer 20 can be made of any type of conductive material, and the appearance decoration layer 30 can be made of any type of insulation material such as ink, rubber, or plastic etc. The appearance decoration layer 30 can be a single-layer structure or a multi-layer structure composed of a plurality of single-layer structures that are stacked on top of one another sequentially. However, the antenna layer 20 and the appearance decoration layer 30 used in the first embodiment are merely examples and are not meant to limit the instant disclosure.

Moreover, the external casing structure further comprising: a substrate unit 4 and an electrical connection unit 5. The substrate unit 4 is disposed under the metal casing unit 1, and the electrical connection unit 5 is electrically connected between the substrate unit 4 and the first antenna track 201 of the antenna unit 2. For example, the electrical connection unit 5 may be a pogo pin or any type of electrical connector. However, the electrical connection unit 5 used in the first embodiment is merely an example and is not meant to limit the instant disclosure.

### Second Embodiment

Referring to FIG. 2, where the second embodiment of the instance disclosure provides an external casing structure for providing an antenna function, comprising: a metal casing unit 1, an antenna unit 2, and an appearance decoration unit 3, and the metal casing unit 1 can be replaced by a plastic casing unit 1′ including at least one plastic casing 10′. Comparing FIG. 2 with FIG. 1, the difference between the second embodiment and the first embodiment is as follows: in the second embodiment, the appearance decoration layer 30 has a first appearance decoration portion 301 disposed on the outer surface 101 of the metal casing 10 to cover the third antenna track 203, a second appearance decoration portion 302 disposed on the bending surface 102 of the metal casing 10 to cover the second antenna track 202, and a third appearance decoration portion 303 disposed on one part of the inner surface 100 of the metal casing 10. The second appearance decoration portion 302 can be extended from the first appearance decoration portion 301 to cover one part of the inner surface 100 of the metal casing 10, and the third appearance decoration portion 303 can be extended from the second appearance decoration portion 302. Therefore, the third appearance decoration portion 303 can be extended to cover one part of the inner surface 100 of the metal casing 10, thus the appearance decoration layer 30 can be firmly positioned on the metal casing 10.

### Third Embodiment

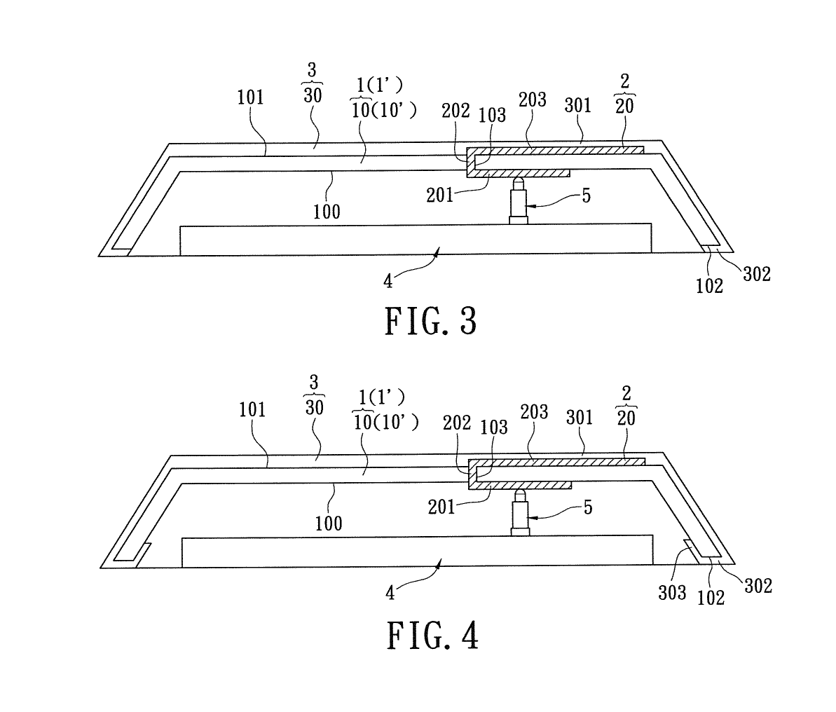

Referring to FIG. 3, where the third embodiment of the instance disclosure provides an external casing structure for providing an antenna function, comprising: a metal casing unit 1, an antenna unit 2, and an appearance decoration unit 3, and the metal casing unit 1 can be replaced by a plastic casing unit 1′ including at least one plastic casing 10′. Comparing FIG. 3 with FIG. 1, the difference between the third embodiment and the first embodiment is as follows: in the third embodiment, the metal casing 10 has at least one connection hole 103 passing through the metal casing 10, thus the connection hole 103 an be communicated between the inner surface 100 and the outer surface 101. In addition, the antenna layer 20 has a first antenna track 201 disposed on the inner surface 100 of the metal casing 10, a second antenna track 202 passing through the connection hole 103 of the metal casing 10 and extended from the first antenna track 201, and a third antenna track 203 disposed on the outer surface 101 of the metal casing 10 and extended from the second antenna track 202. Moreover, the appearance decoration layer 30 has a first appearance decoration portion 301 disposed on the outer surface 101 of the metal casing 10 to cover the third antenna track 203 and a second appearance decoration portion 302 disposed on the bending surface 102 of the metal casing 10 and extended from the first appearance decoration portion 301. For example, the connection hole 103 of the metal casing 10 can be filled with the second antenna track 202. Of course, the connection hole 103 of the metal casing 10 also cannot be filled with the second antenna track 202, thus the second antenna track 202 can only be disposed on the inner surface of the connection hole 103 of the metal casing 103.

### Fourth Embodiment

Referring to FIG. 4, where the fourth embodiment of the instance disclosure provides an external casing structure for providing an antenna function, comprising: a metal casing unit 1, an antenna unit 2, and an appearance decoration unit 3, and the metal casing unit 1 can be replaced by a plastic casing unit 1′ including at least one plastic casing 10′. Comparing FIG. 4 with FIG. 3, the difference between the fourth embodiment and the third embodiment is as follows: in the fourth embodiment, the appearance decoration layer 30 has a first appearance decoration portion 301 disposed on the outer surface 101 of the metal casing 10 to cover the third antenna track 203, a second appearance decoration portion 302 disposed on the bending surface 102 of the metal casing 10 and extended from the first appearance decoration portion 301, and a third appearance decoration portion 303 disposed on one part of the inner surface 100 of the metal casing 10 and extended from the second appearance decoration portion 302. Therefore, the third appearance decoration portion 303 can be extended to cover one part of the inner surface 100 of the metal casing 10, thus the appearance decoration layer 30 can be firmly positioned on the metal casing 10.

In conclusion, the appearance decoration layer can be disposed on the outer surface of the metal casing or the plastic casing to prevent the antenna layer from being touched directly by the user, thus the antenna layer can be used to transmit or receive signals normally.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. An external casing structure for providing an antenna function, comprising:
a metal casing unit including at least one metal casing;
an antenna unit including at least one antenna layer disposed on the at least one metal casing, wherein the at least one antenna layer is extended from the inner surface of the at least one metal casing to the outer surface of the at least one metal casing; and
an appearance decoration unit including at least one appearance decoration layer disposed on the outer surface of the at least one metal casing, wherein one part of the at least one antenna layer is covered with the at least one appearance decoration layer.

2. The external casing structure of claim 1, wherein the at least one metal casing has at least one bending surface formed between the inner surface and the outer surface thereof, and the at least one antenna layer has a first antenna track disposed on the inner surface of the at least one metal casing, a second antenna track disposed on the at least one bending surface of the at least one metal casing and extended from the first antenna track, and a third antenna track disposed on the outer surface of the at least one metal casing and extended from the second antenna track.

3. The external casing structure of claim 2, wherein the at least one appearance decoration layer has a first appearance decoration portion disposed on the outer surface of the at least one metal casing to cover the third antenna track and a second appearance decoration portion disposed on the at least one bending surface of the at least one metal casing to cover the second antenna track, and the second appearance decoration portion is extended from the first appearance decoration portion.

4. The external casing structure of claim 2, wherein the at least one appearance decoration layer has a first appearance decoration portion disposed on the outer surface of the at least one metal casing to cover the third antenna track, a second appearance decoration portion disposed on the at least one bending surface of the at least one metal casing to cover the second antenna track, and a third appearance decoration portion disposed on one part of the at least one inner surface of the at least one metal casing, wherein the second appearance decoration portion is extended from the first appearance decoration portion, and the third appearance decoration portion is extended from the second appearance decoration portion.

5. The external casing structure of claim 1, wherein the at least one metal casing has at least one connection hole communicated between the inner surface and the outer surface thereof, and the at least one antenna layer has a first antenna track disposed on the inner surface of the at least one metal casing, a second antenna track passing through the at least one connection hole of the at least one metal casing and extended from the first antenna track, and a third antenna track disposed on the outer surface of the at least one metal casing and extended from the second antenna track.

6. The external casing structure of claim 5, wherein the at least one connection hole of the at least one metal casing is filled with the second antenna track.

7. The external casing structure of claim 5, wherein the second antenna track is disposed on the inner surface of the at least one connection hole of the at least one metal casing.

8. The external casing structure of claim 5, wherein the at least one metal casing has at least one bending surface formed between the inner surface and the outer surface thereof, and the at least one appearance decoration layer has a first appearance decoration portion disposed on the outer surface of the at least one metal casing to cover the third antenna track and a second appearance decoration portion disposed on the at least one bending surface of the at least one metal casing and extended from the first appearance decoration portion.

9. The external casing structure of claim 5, wherein the at least one metal casing has at least one bending surface formed between the inner surface and the outer surface thereof, and the at least one appearance decoration layer has a first appearance decoration portion disposed on the outer surface of the at least one metal casing to cover the third antenna track, a second appearance decoration portion disposed on the at least one bending surface of the at least one metal casing and extended from the first appearance decoration portion, and a third appearance decoration portion disposed on one part of the at least one inner surface of the at least one metal casing and extended from the second appearance decoration portion.

10. The external casing structure of claim 1, further comprising: a substrate unit and an electrical connection unit, wherein the substrate unit is disposed under the metal casing unit, and the electrical connection unit is electrically connected between the substrate unit and the antenna unit.

11. An external casing structure for providing an antenna function, comprising:
a plastic casing unit including at least one plastic casing;
an antenna unit including at least one antenna layer disposed on the at least one plastic casing, wherein the at least one antenna layer is extended from the inner surface of the at least one plastic casing to the outer surface of the at least one plastic casing; and
an appearance decoration unit including at least one appearance decoration layer disposed on the outer surface of the at least one plastic casing, wherein one part of the at least one antenna layer is covered with the at least one appearance decoration layer.

12. The external casing structure of claim 11, wherein the at least one plastic casing has at least one bending surface formed between the inner surface and the outer surface thereof, and the at least one antenna layer has a first antenna track disposed on the inner surface of the at least one plastic casing, a second antenna track disposed on the at least one bending surface of the at least one plastic casing and extended from the first antenna track, and a third antenna track disposed on the outer surface of the at least one plastic casing and extended from the second antenna track.

13. The external casing structure of claim 12, wherein the at least one appearance decoration layer has a first appearance decoration portion disposed on the outer surface of the at least one plastic casing to cover the third antenna track and a second appearance decoration portion disposed on the at least one bending surface of the at least one plastic casing to cover the second antenna track, and the second appearance decoration portion is extended from the first appearance decoration portion.

14. The external casing structure of claim 12, wherein the at least one appearance decoration layer has a first appearance decoration portion disposed on the outer surface of the at least one plastic casing to cover the third antenna track, a second appearance decoration portion disposed on the at least one bending surface of the at least one plastic casing to cover the second antenna track, and a third appearance decoration portion disposed on one part of the at least one inner surface of the at least one plastic casing, wherein the second appearance decoration portion is extended from the first appearance decoration portion, and the third appearance decoration portion is extended from the second appearance decoration portion.

15. The external casing structure of claim 11, wherein the at least one plastic casing has at least one connection hole communicated between the inner surface and the outer surface thereof, and the at least one antenna layer has a first antenna track disposed on the inner surface of the at least one plastic casing, a second antenna track passing through the at least one connection hole of the at least one plastic casing and extended from the first antenna track, and a third antenna track disposed on the outer surface of the at least one plastic casing and extended from the second antenna track.

16. The external casing structure of claim 15, wherein the at least one connection hole of the at least one plastic casing is filled with the second antenna track.

17. The external casing structure of claim 15, wherein the second antenna track is disposed on the inner surface of the at least one connection hole of the at least one plastic casing.

18. The external casing structure of claim 15, wherein the at least one plastic casing has at least one bending surface formed between the inner surface and the outer surface thereof, and the at least one appearance decoration layer has a first appearance decoration portion disposed on the outer surface of the at least one plastic casing to cover the third antenna track and a second appearance decoration portion disposed on the at least one bending surface of the at least one plastic casing and extended from the first appearance decoration portion.

19. The external casing structure of claim 15, wherein the at least one plastic casing has at least one bending surface formed between the inner surface and the outer surface thereof, and the at least one appearance decoration layer has a first appearance decoration portion disposed on the outer surface of the at least one plastic casing to cover the third antenna track, a second appearance decoration portion disposed on the at least one bending surface of the at least one plastic casing and extended from the first appearance decoration portion, and a third appearance decoration portion disposed on one part of the at least one inner surface of the at least one plastic casing and extended from the second appearance decoration portion.

20. The external casing structure of claim 11, further comprising: a substrate unit and an electrical connection unit, wherein the substrate unit is disposed under the plastic casing unit, and the electrical connection unit is electrically connected between the substrate unit and the antenna unit.
